(19) United States
(12) Patent Application Publication
(10) Pub. No.: US 2025/0364739 A1
(43) Pub. Date: Nov. 27, 2025

(54) CONNECTOR

(71) Applicant: Yazaki Corporation, Tokyo (JP)

(72) Inventors: Atsunori IWASHITA, Shizuoka (JP); Masayuki Ishigami, Shizuoka (JP)

(73) Assignee: Yazaki Corporation, Tokyo (JP)

(21) Appl. No.: 19/212,837

(22) Filed: May 20, 2025

(30) Foreign Application Priority Data
May 21, 2024 (JP) 2024-082585

(51) Int. Cl. H01R 4/36; H01R 4/30

(52) U.S. Cl. CPC H01R 4/36; H01R 4/302

(57) ABSTRACT

In a connector including a first housing, a second housing configured to be fitted to the first housing, a first conductive member being accommodated in the first housing, a second conductive member being accommodated in the second housing and being electrically connected to the first conductive member, and a fastening member configured to electrically connect the first conductive member and the second conductive member to each other by being fastened to a fastening portion, the first conductive member and the second conductive member are provided with an overlapping portion, the fastening portion is arranged on one side in an overlapping direction of the overlapping portion, and the fastening member is fastened to the fastening portion, presses the overlapping portion toward the overlapping direction, and electrically connects the first conductive member and the second conductive member to each other.

### CROSS-REFERENCE TO RELATED APPLICATIONS

The present application is based on, and claims priority from the prior Japanese Patent Application No. 2024-082585, filed on May 21, 2024, the entire contents of which are incorporated herein by reference.

### TECHNICAL FIELD

The present disclosure relates to a connector.

### BACKGROUND

Hitherto, there has been known a connector including a first housing, a second housing that can be fitted to the first housing, a first conductive member that is accommodated in the first housing, and a second conductive member that is accommodated in the second housing and is electrically connected to the first conductive member. The connector further includes a bolt being a fastening member that is fastened to a fastening portion to electrically connect the first conductive member and the second conductive member to each other (see JP 2016-213048 A).

In the connector, the first conductive member and the second conductive member are provided with through holes that are arranged at positions matching with each other when the first housing and the second housing are fitted to each other. The bolt is inserted into the respective through holes, and is fastened to the fastening portion, thereby electrically connecting the first conductive member and the second conductive member to each other.

### SUMMARY OF THE INVENTION

Incidentally, in the connector as disclosed in JP 2016-213048 A, the bolt is inserted into the first conductive member and the second conductive member. Thus, for example, even when the first housing and the second housing are to be fitted to each other while the fastening member is temporarily held by the fastening portion, the fastening member cannot be inserted into the through holes, and fitting cannot be achieved. Therefore, when the first housing and the second housing are to be fitted to each other, removal of the fastening member is required, and management such as storage of the fastening member in addition to that of the connector is required, which leads to degradation of assemblability.

The present disclosure has been made in view of such a problem in the related art. Further, an object of the present disclosure is to provide a connector that can improve assemblability.

A connector according to an embodiment includes a first housing, a second housing configured to be fitted to the first housing, a first conductive member being accommodated in the first housing, a second conductive member being accommodated in the second housing and being electrically connected to the first conductive member, and a fastening member configured to electrically connect the first conductive member and the second conductive member to each other by being fastened to a fastening portion, wherein the first conductive member and the second conductive member are provided with an overlapping portion where the first conductive member and the second conductive member are arranged to overlap with each other while the first housing and the second housing are fitted to each other, the fastening portion is arranged on one side in an overlapping direction of the overlapping portion, and the fastening member is fastened to the fastening portion, presses the overlapping portion toward the overlapping direction, and electrically connects the first conductive member and the second conductive member to each other

According to the present disclosure, a connector that can improve assemblability can be provided.

### BRIEF DESCRIPTION OF DRAWINGS

FIG. 1 is a perspective view of a connector according to the present embodiment.

FIG. 2 is a cross-sectional view of the connector according to the present embodiment.

FIG. 3 is a cross-sectional view of a first housing of the connector according to the present embodiment, the first housing accommodating a first conductive member.

FIG. 4 is a cross-sectional view of a second housing of the connector according to the present embodiment, the second housing accommodating a second conductive member.

FIG. 5 is an enlarged top view of main parts, illustrating a state in which a fastening member of the connector according to the present embodiment is temporarily held by a fastening portion.

FIG. 6 is an enlarged top view of main parts, illustrating a state in which the fastening member of the connector according to the present embodiment is fastened to the fastening portion.

FIG. 7 is an enlarged view of main parts, illustrating a state in which the fastening member is arranged in an opening portion of the connector according to the present embodiment.

FIG. 8 is a perspective view of the first conductive member of the connector according to the present embodiment.

FIG. 9 is a side view of the first conductive member of the connector according to the present embodiment.

FIG. 10 is a perspective view of the connector according to the present embodiment, illustrating a state in which the fastening portion is arranged at the first conductive member.

FIG. 11 is a perspective view of the second conductive member of the connector according to the present embodiment.

FIG. 12 is a perspective view of the fastening member of the connector according to the present embodiment.

### DETAILED DESCRIPTION OF THE INVENTION

With reference to the drawings, a connector according to the present embodiment is described in detail. Note that the dimensional ratios in the drawings are exaggerated for explanatory purposes, and may differ from the actual ratios.

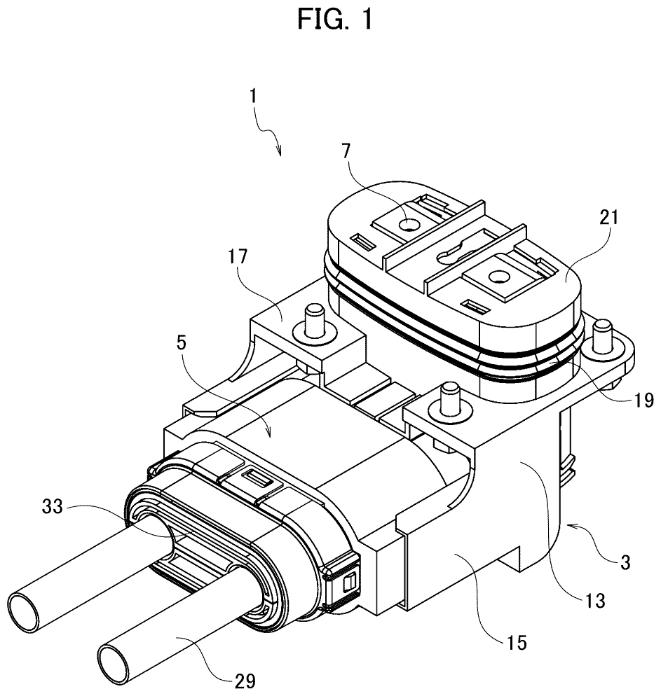

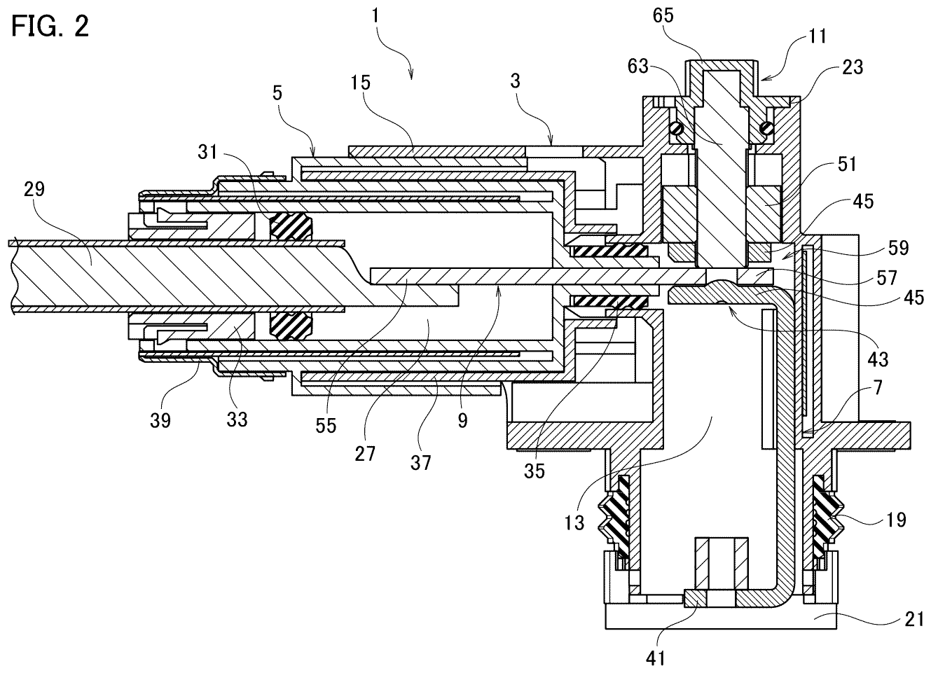

As illustrated in FIG. 1, a connector 1 according to the present embodiment electrically connects two electric components (omitted in illustration), for example, a power source and a device, or a device and a device to each other. The connector 1 includes a first housing 3 that accommodates a first conductive member 7 (see FIG. 2) electrically connected to one electric component and a second housing 5 that accommodates a second conductive member 9 (see FIG. 2) electrically connected to the other electric component and can be fitted to the first housing 3. When the first housing 3 and the second housing 5 are fitted to each other, the first conductive member 7 and the second conductive member 9 are arranged to overlap with each other. The first conductive member 7 and the second conductive member 9 that overlap with each other are electrically connected to each other by fastening of a fastening member 11 (see FIG. 2). Consequently, the two electric components are electrically connected to each other.

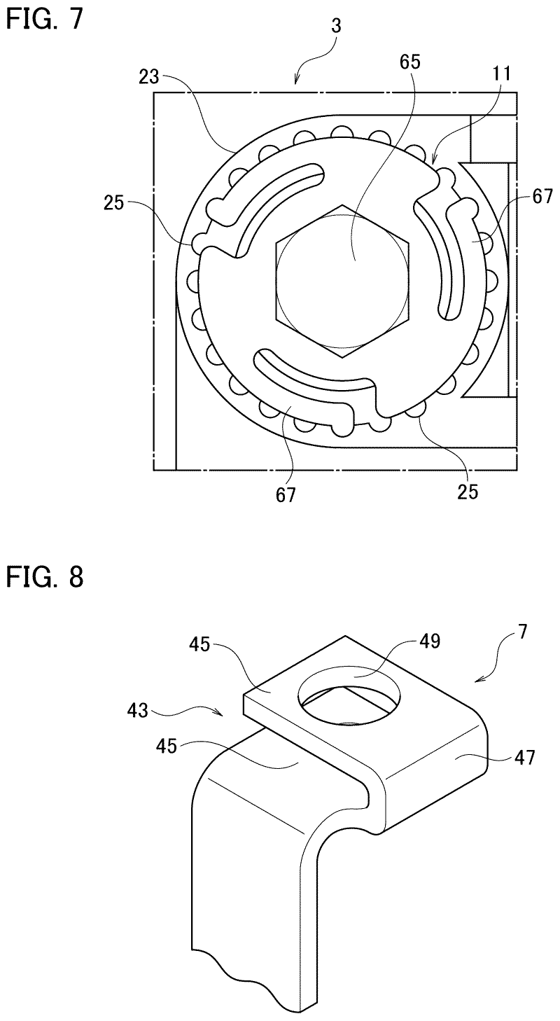

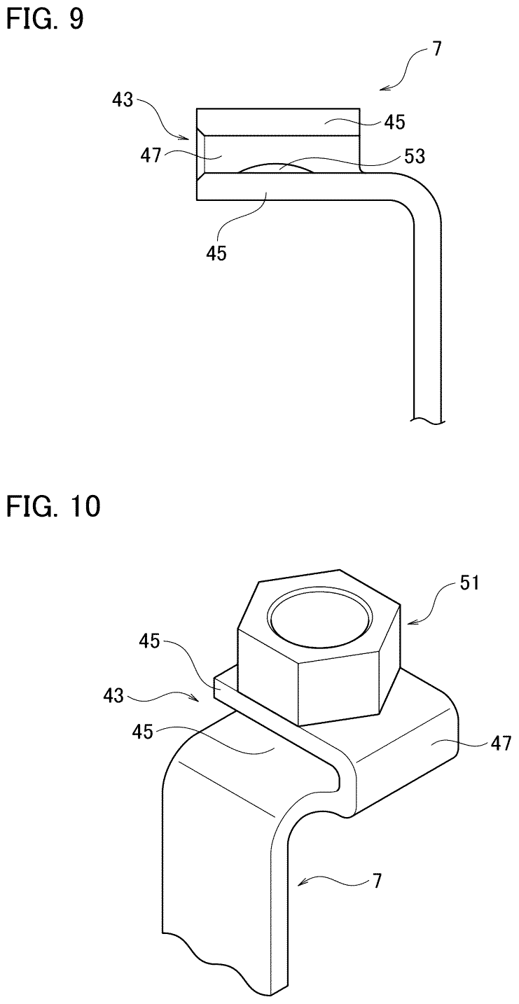

As illustrated in FIG. 1 to FIG. 12, the connector 1 includes the first housing 3, the second housing 5, the first conductive member 7, the second conductive member 9, and the fastening member 11.

As illustrated in FIG. 1 to FIG. 3 and FIG. 5 to FIG. 7, the first housing 3 is formed of a conductive material such as a metal material. Note that the first housing 3 may be formed of an insulating material such as a synthetic resin. The first housing 3 is formed to have an L-like housing shape so that the first conductive member 7 can be accommodated therein and the second housing 5 can be fitted therein. The first housing 3 includes a plurality of first accommodation portions 13 (specifically, two in this case) that accommodate the first conductive member 7 therein and a fitting portion 15 to which the second housing 5 is fitted. The first accommodation portion 13 and the fitting portion 15 extend in a tubular shape toward directions orthogonal to each other, and communicate with each other inside. On the outer side of the first housing 3, a plurality of fixing portions 17 fixed to the one electric component via a plurality of bolts are provided. On an outer periphery of one end side of the first accommodation portion 13, a first sealing member 19 that closely contacts with the one electric component and seals the space between the first housing 3 and the one electric component is arranged. A sealing holder 21 assembled to close the opening of the first accommodation portion 13 maintains the arrangement position of the first sealing member 19 with respect to the first housing 3. In the sealing holder 21, an opening from which the first conductive member 7 is exposed is provided. On the other end side of the first accommodation portion 13, there are provided a plurality of opening portions 23 (specifically, two in this case) into which the fastening member 11 for electrically connecting the first conductive member 7 and the second conductive member 9 to each other is inserted. A plurality of engaged portions 25 are provided on the inner surface of the opening portion 23, and are arranged at an equal interval in a circumferential direction (a rotation direction of the fastening member 11) to form a shape having recesses and protrusions.

As illustrated in FIG. 1, FIG. 2 and FIG. 4, the second housing 5 is formed of an insulating material such as a synthetic resin. The second housing 5 is formed to have such a housing shape as to accommodate the second conductive member 9 therein and be fitted to the inside of the fitting portion 15 of the first housing 3. On the outer side of the second housing 5, a locking portion (omitted in illustration) that can be engaged with a locked portion (omitted in illustration) provided to the fitting portion 15 of the first housing 3 is provided. When the locking portion and the locked portion are engaged with each other, the fitting state between the first housing 3 and the second housing 5 can be maintained. The second housing 5 includes a plurality of second accommodation portions 27 (specifically, two in this case) that accommodate the second conductive member 9 therein. Each of both the sides of the second accommodation portion 27 in the length direction is opened so that a part of the second conductive member 9 is exposed and an electric wire 29 electrically connected to the second conductive member 9 is drawn to the outside. The end portion side of the electric wire 29 that is drawn from the second housing 5 is electrically connected to the other electric component. On the outer periphery of the electric wire 29 positioned inside the second accommodation portion 27, an electric wire sealing member 31 that closely contacts with the second housing 5 and seals the space between the second housing 5 and the electric wire 29 is arranged. An electric wire sealing holder 33 assembled to close the opening on the drawing side of the electric wire 29 of the second accommodation portion 27 maintains the arrangement position of the electric wire sealing member 31 with respect to the second housing 5. On the outer periphery of the second accommodation portion 27 on the opening side on which a part of the second conductive member 9 is exposed, a second sealing member 35 that closely contacts with the first housing 3 and seals the space between the first housing 3 and the second housing 5 is arranged. On the outer periphery of the second housing 5 on the first housing 3 side, a housing shielding member 37 that is electrically connected to the first housing 3 and forms a shielding circuit at the time of fitting to the fitting portion 15 of the first housing 3 is mounted. On the outer periphery of the second housing 5 on the electric wire 29 side, an electric wire shielding member 39 that is electrically connected to a shielding member (omitted in illustration) covering the outer periphery of the electric wire 29 drawn from the second housing 5 and forms a shielding circuit is mounted. The housing shielding member 37 and the electric wire shielding member 39 form the shielding circuits, and thus entry of a noise and the like into the connector 1 and leakage of a noise and the like from the connector 1 can be prevented.

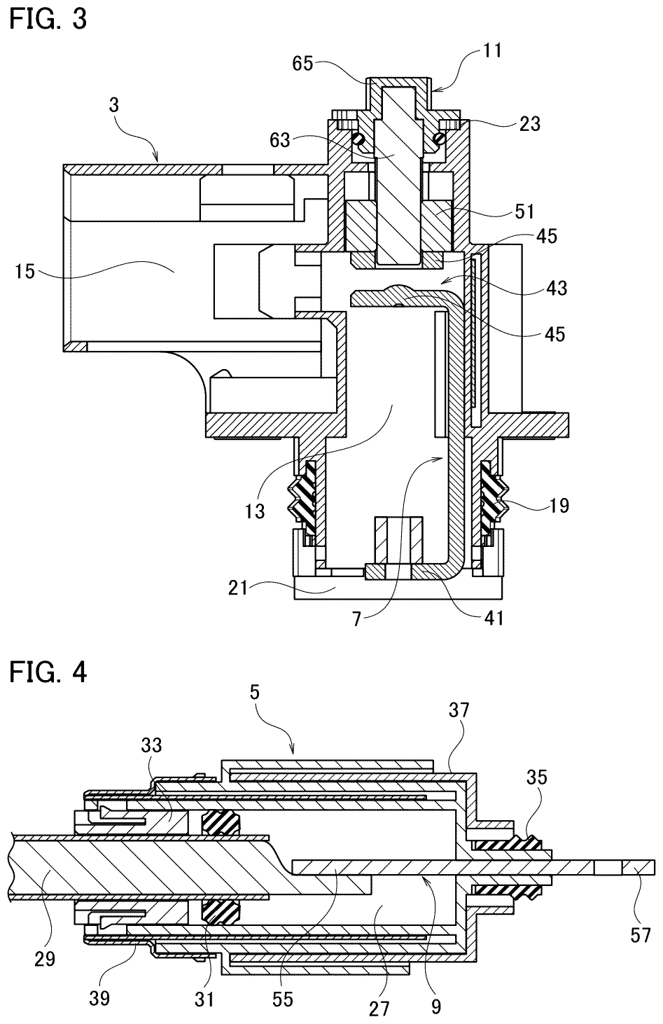

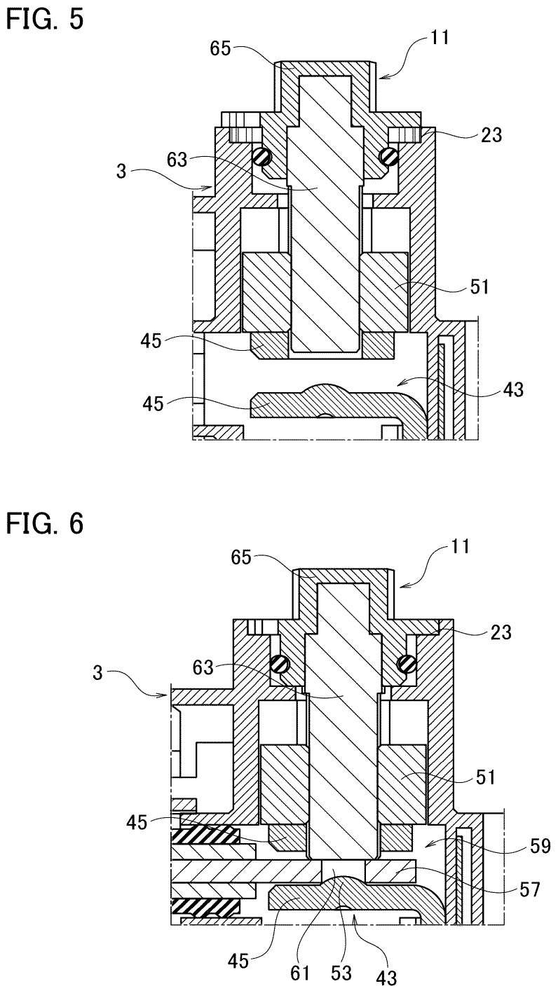

As illustrated in FIG. 2, FIG. 3, FIG. 5, FIG. 6, and FIG. 8 to FIG. 10, the first conductive member 7 is formed of a conductive material such as a metal material, and is formed to have a plate-like shape such as a bus bar. The plurality of first conductive members 7 (specifically, two in this case) are used. The first conductive member 7 is formed to have a U-like shape by bending both the end sides toward the same direction. One end side of the first conductive member 7 serves as a component connecting portion 41 that is electrically connected to the one electric component. The component connecting portion 41 is arranged to be exposed from the opening of the sealing holder 21 to the outside of the first housing 3 while the first conductive member 7 is accommodated in the first accommodation portion 13 of the first housing 3. In the component connecting portion 41, a through hole is formed, and a nut is fixed to a position corresponding to the through hole on the inner side of the first housing 3. The bolt (omitted in illustration) is inserted into the through hole and fastened to the nut while the conductive member (omitted in illustration) on the one electric component side is arranged, and thus the component connecting portion 41 electrically connects the first conductive member 7 and the one electric component to each other. The other end side of the first conductive member 7 serves as a first connecting portion 43 electrically connected to the second conductive member 9. The first connecting portion 43 is formed to have a U-like shape, including a pair of facing portions 45 and 45 that are arranged at an interval to face each other and a coupling portion 47 that couples the pair of facing portions 45 and 45 to each other. The space between the pair of facing portions 45 and 45 is set to an interval into which the second conductive member 9 can be inserted while the first housing 3 and the second housing 5 are fitted to each other. The coupling portion 47 is arranged at such a position that the second conductive member 9 can be inserted between the pair of facing portions 45 and 45 while the first housing 3 and the second housing 5 are fitted to each other. One of the pair of facing portions 45 and 45 (the facing portion 45 positioned on the upper side in FIG. 8) is provided with a through hole 49 into which the fastening member 11 can be inserted. On the outer surface of the one facing portion 45, a fastening portion 51 formed of a nut to which the fastening member 11 is fastened is fixed and arranged at a position corresponding to the through hole 49. When the fastening portion 51 is arranged at the one facing portion 45, it is not required to provide the first housing 3 or the second housing 5 with a fastening portion such as a terminal block to which the fastening member 11 is fastened. Thus, the structures of the first housing 3 and the second housing 5 can be simplified. The other one of the pair of facing portions 45 and 45 (the facing portion 45 positioned on the lower side in FIG. 8) is provided with a contact point portion 53 protruding toward the one facing portion 45. The first connecting portion 43 is arranged at the position corresponding to the opening portion 23 of the first accommodation portion 13 on the inner side of the first housing 3 while the first conductive member 7 is accommodated in the first accommodation portion 13 of the first housing 3.

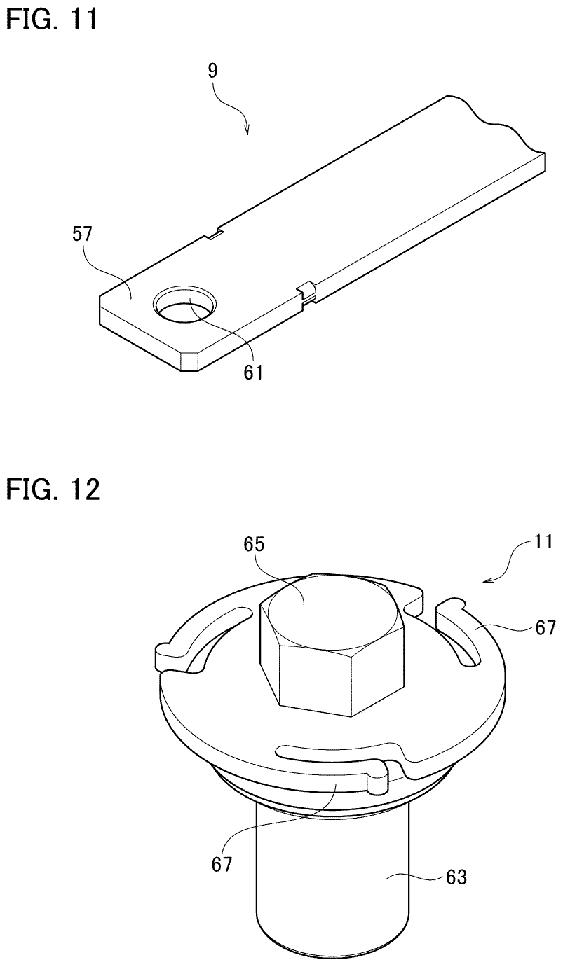

As illustrated in FIG. 2, FIG. 4, and FIG. 11, the second conductive member 9 is formed of a conductive material such as a metal material, and is formed to have a plate-like shape such as a bus bar. The plurality of second conductive members 9 (specifically, two in this case) are used in correspondence with the first conductive members 7. The second conductive member 9 is formed to have a linear shape extending toward a direction orthogonal to the linear portion of the first conductive member 7. One end side of the second conductive member 9 serves as an electric wire connecting portion 55 electrically connected to a terminal portion of the electric wire 29. The electric wire connecting portion 55 is joined to the terminal portion of the electric wire 29 by crimping or the like, and electrically connects the second conductive member 9 and the electric wire 29 to each other. The other end side of the second conductive member 9 serves as a second connecting portion 57 electrically connected to the first connecting portion 43 of the first conductive member 7. The second connecting portion 57 is arranged to be exposed from the opening of the second accommodation portion 27 to the outside of the second housing 5 while the second conductive member 9 is accommodated in the second accommodation portion 27 of the second housing 5. The second connecting portion 57 is arranged to be sandwiched between the pair of facing portions 45 and 45, and thus overlap with the first connecting portion 43 of the first conductive member 7 on the inner side of the first housing 3 while the first housing 3 and the second housing 5 are fitted to each other. A portion where the first connecting portion 43 and the second connecting portion 57 overlap with each other forms an overlapping portion 59.

Inside the first housing 3, the overlapping portion 59 is arranged at a position corresponding to the opening portion 23. In the overlapping portion 59, on one side in an overlapping direction of the first connecting portion 43 and the second connecting portion 57, the fastening portion 51 is arranged at a position closest to the opening portion 23. In the overlapping portion 59, the second connecting portion 57 is provided with a contact point hole portion 61 formed of a through hole accommodating the contact point portion 53. Note that the contact point hole portion 61 may be formed as a recess in the surface of the second conductive member 9, instead of a through hole. In the overlapping portion 59, the contact point portion 53 is accommodated in the contact point hole portion 61. With this, the arrangement position at which the first conductive member 7 and the second conductive member 9 contact with each other can be maintained, and reliability of electric connection between the first conductive member 7 and the second conductive member 9 can be maintained. In the opening portion 23, the fastening member 11 is fastened to the fastening portion 51. With this, in the overlapping portion 59, the first connecting portion 43 (the other facing portion 45) and the second connecting portion 57 contact with each other, and thus the first conductive member 7 and the second conductive member 9 are electrically connected to each other.

As illustrated FIG. 2, FIG. 3, FIG. 5 to FIG. 7, and FIG. 12, the plurality of fastening members 11 (specifically, two in this case) are used in correspondence with the plurality of first conductive members 7 and the plurality of second conductive members 9 (specifically, two for each in this case). The fastening member 11 includes a shaft portion 63 and a resin portion 65.

The shaft portion 63 is formed of a metal material or the like, for example. The shaft portion 63 extends along an extension direction of the first accommodation portion 13 of the first housing 3. The outer periphery of the shaft portion 63 is formed to have a screw-like shape so as to be fastened to the fastening portion 51. The length of the shaft portion 63 is set to such a length that the end thereof exposed from the fastening portion 51 can press the second conductive member 9 (the second connecting portion 57) at the time of fastening to the fastening portion 51.

The resin portion 65 is formed of an insulating material such as a synthetic resin, and is arranged at one end side of the shaft portion 63 exposed from the opening portion 23. The inner surface of the resin portion 65 is formed to have a screw-like shape that can be fastened to the shaft portion 63. Note that the resin portion 65 may be insert-molded integrally with the shaft portion 63 so that the shaft portion 63 is positioned inside. The resin portion 65 includes an outer surface exposed from the opening portion 23, and the outer surface is formed to have a polygonal shape such as a hexagonal shape that can be fastened by a jig or the like. On the outer periphery of the resin portion 65 that is positioned inside the opening portion 23, an O ring being a sealing member that closely contacts with the first housing 3 and seals the space between the first housing 3 and the resin portion 65 is arranged. On the outer periphery of the resin portion 65, a plurality of engaging pieces 67 (specifically, three in this case) are provided in an elastically deformable manner, and free ends thereof can be engaged with the plurality of engaged portions 25 of the opening portion 23. When the shaft portion 63 rotates in a fastening direction with respect to the fastening portion 51, the engaging piece 67 is elastically deformed radially inward to cancel engagement with the engaged portion 25. Thus, the shaft portion 63 can rotate in the fastening direction at the time of fastening to the fastening portion 51, and the first conductive member 7 and the second conductive member 9 can be electrically connected to each other in a stable manner. In contrast, when the shaft portion 63 rotates in a fastening cancellation direction with respect to the fastening portion 51, the engaging piece 67 maintains engagement with the engaged portion 25 without being elastically deformed. Thus, the shaft portion 63 cannot rotate in the fastening cancellation direction during fastening to the fastening portion 51. Therefore, without loosening the fastening state of the fastening member 11 with respect to the fastening portion 51, the conductive state between the first conductive member 7 and the second conductive member 9 can be maintained in a stable manner.

The fastening member 11 is temporarily held by fastening the shaft portion 63 to the fastening portion 51 to a certain extent while the first conductive member 7 is accommodated in the first housing 3. While the fastening member 11 is temporarily held, the distal end of the shaft portion 63 is prevented from being exposed from the fastening portion 51. The first housing 3 in which the fastening member 11 is temporarily held is fitted to the second housing 5, and the first conductive member 7 and the second conductive member 9 overlap with each other to form the overlapping portion 59 without interference from the fastening member 11. The fastening member 11 is fastened to the fastening portion 51 by rotating the resin portion 65, which is exposed from the opening portion 23, by a jig or the like while the first housing 3 and the second housing 5 are fitted to each other. When the fastening member 11 is fastened to the fastening portion 51, the distal end of the shaft portion 63 exposed from the fastening portion 51 presses the second connecting portion 57 toward the overlapping direction in the overlapping portion 59, and the second connecting portion 57 and the first connecting portion 43 (the other facing portion 45) contact with each other. When the first connecting portion 43 and the second connecting portion 57 contact with each other due to fastening of the fastening member 11, the first conductive member 7 and the second conductive member 9 are electrically connected to each other, and the two electric components are electrically connected to each other.

The fastening member 11 is fastened to the fastening portion 51, presses the overlapping portion 59, and then electrically connects the first conductive member 7 and the second conductive member 9 to each other. Thus, there is no need to insert the fastening member 11 into the first conductive member 7 and the second conductive member 9. The fastening portion 51 to which the fastening member 11 is fastened is arranged on one side in the overlapping direction of the overlapping portion 59. Thus, even when the fastening member 11 is temporarily held by the fastening portion 51, the fastening member 11 does not interfere with the first conductive member 7 and the second conductive member 9 in the overlapping portion 59. Thus, even when the fastening member 11 is temporarily held by the fastening portion 51, the first housing 3 and the second housing 5 can be fitted to each other. When the fastening member 11 is temporarily held, management of the fastening member 11 in addition to that of the connector 1 is not required, and assemblability can be improved.

The connector 1 described above includes the first housing 3, the second housing 5 that can be fitted to the first housing 3, the first conductive member 7 that is accommodated in the first housing 3, and the second conductive member 9 that is accommodated in the second housing 5 and is electrically connected to the first conductive member 7. The connector 1 further includes the fastening member 11 that electrically connects the first conductive member 7 and the second conductive member 9 to each other by being fastened to the fastening portion 51. Further, the first conductive member 7 and the second conductive member 9 are provided with the overlapping portion 59 where the first conductive member 7 and the second conductive member 9 are arranged to overlap with each other while the first housing 3 and the second housing 5 are fitted to each other. Further, the fastening portion 51 is arranged on one side in the overlapping direction of the overlapping portion 59. Further, the fastening member 11 is fastened to the fastening portion 51, presses the overlapping portion 59 toward the overlapping direction, and electrically connects the first conductive member 7 and the second conductive member 9 to each other.

The fastening member 11 is fastened to the fastening portion 51, presses the overlapping portion 59, and then electrically connects the first conductive member 7 and the second conductive member 9 to each other. Thus, there is no need to insert the fastening member 11 into the first conductive member 7 and the second conductive member 9. The fastening portion 51 to which the fastening member 11 is fastened is arranged on one side in the overlapping direction of the overlapping portion 59. Thus, even when the fastening member 11 is temporarily held by the fastening portion 51, the fastening member 11 does not interfere with the first conductive member 7 and the second conductive member 9 in the overlapping portion 59. Thus, even when the fastening member 11 is temporarily held by the fastening portion 51, the first housing 3 and the second housing 5 can be fitted to each other. When the fastening member 11 is temporarily held, management of the fastening member 11 in addition to that of the connector 1 is not required, and assemblability can be improved.

Therefore, in the connector 1 described above, the fastening member 11 can be held temporarily, and management of the fastening member 11 in addition to that of the connector 1 is not required, which can improve assemblability.

Further, one of the first housing 3 and the second housing 5 is provided with the opening portion 23 from which the fastening member 11 is exposed to the outside. Further, the opening portion 23 is provided with the plurality of engaged portions 25 arranged in the rotation direction of the fastening member 11. Further, the fastening member 11 is provided with the engaging piece 67 that can be engaged with the engaged portion 25 and can be elastically deformed. Further, the engaging piece 67 is elastically deformed to cancel engagement with the engaged portion 25 when the fastening member 11 rotates in the fastening direction, and is prevented from being elastically deformed to maintain engagement with the engaged portion 25 when the fastening member 11 rotates in the fastening cancellation direction.

Thus, the fastening member 11 can rotate in the fastening direction at the time of fastening to the fastening portion 51, and the first conductive member 7 and the second conductive member 9 can be electrically connected to each other in a stable manner. In contrast, the fastening member 11 cannot rotate in the fastening cancellation direction during fastening to the fastening portion 51. Thus, without loosening the fastening state of the fastening member 11 with respect to the fastening portion 51, the conductive state between the first conductive member 7 and the second conductive member 9 can be maintained in a stable manner.

Further, one of the first conductive member 7 and the second conductive member 9 is provided with the pair of facing portions 45 and 45 that are arranged to sandwich the other one thereof in the overlapping direction in the overlapping portion 59 while the first housing 3 and the second housing 5 are fitted to each other. Further, the fastening portion 51 is arranged at one of the pair of facing portions 45 and 45.

Thus, it is not required to provide the first housing 3 or the second housing 5 with a fastening portion such as a terminal block to which the fastening member 11 is fastened, and the structures of the first housing 3 and the second housing 5 can be simplified.

Further, the overlapping portion 59 is provided with the contact point portion 53 protruding from one of the first conductive member 7 and the second conductive member 9 toward the other one thereof and the contact point hole portion 61 in which the contact point portion 53 is accommodated.

Thus, the arrangement position at which the first conductive member 7 and the second conductive member 9 contact with each other can be maintained by accommodating the contact point portion 53 in the contact point hole portion 61, and reliability of electric connection between the first conductive member 7 and the second conductive member 9 can be maintained.

While the present embodiment is described above, the present embodiment is not limited thereto, and various modifications can be made within the scope of the gist of the present embodiment.

For example, the two first conductive members and the two second conductive members (forming two sets) are provided, but the numbers are not limited thereto. One first conductive member and one second conductive member (forming one set) or three or more first conductive members and three or more second conductive members (forming three sets or more) may be provided.

Further, in the first housing, the first accommodation portion and the fitting portion extend in the orthogonal directions, but are not limited thereto. The first accommodation portion and the fitting portion may extend in parallel directions. In such a case, similarly to the second conductive member, the first conductive member may be formed to have a linear plate-like shape.

Further, the opening portion is provided to the first housing, but is not limited thereto. When the overlapping portion is positioned on the inner side of the second housing, the opening portion may be provided to the second housing.

Further, the contact point portion is provided to the first conductive member, and the contact point hole portion is provided to the second conductive member. However, the contact point portion and the contact point hole portion are not limited thereto. The contact point portion may be provided to the second conductive member, and the contact point hole portion may be provided to the first conductive member.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a first housing;
a second housing configured to be fitted to the first housing;
a first conductive member being accommodated in the first housing;
a second conductive member being accommodated in the second housing and being electrically connected to the first conductive member; and
a fastening member configured to electrically connect the first conductive member and the second conductive member to each other by being fastened to a fastening portion, wherein
the first conductive member and the second conductive member are provided with an overlapping portion where the first conductive member and the second conductive member are arranged to overlap with each other while the first housing and the second housing are fitted to each other,
the fastening portion is arranged on one side in an overlapping direction of the overlapping portion, and
the fastening member is fastened to the fastening portion, presses the overlapping portion toward the overlapping direction, and electrically connects the first conductive member and the second conductive member to each other.

2. The connector according to claim 1, wherein
one of the first housing and the second housing is provided with an opening portion from which the fastening member is exposed to an outside,
the opening portion is provided with a plurality of engaged portions arranged in a rotation direction of the fastening member,
the fastening member is provided with an engaging piece in an elastically deformable manner, the engaging piece being configured to be engaged with the engaged portion,
the engaging piece is elastically deformed to cancel engagement with the engaged portion when the fastening member rotates in a fastening direction, and is prevented from being elastically deformed to maintain engagement with the engaged portion when the fastening member rotates in a fastening cancellation direction.

3. The connector according to claim 1, wherein
one of the first conductive member and the second conductive member is provided with a pair of facing portions arranged to sandwich the other one thereof in the overlapping direction in the overlapping portion when the first housing and the second housing are fitted to each other,
the fastening portion is provided to one of the pair of facing portions.

4. The connector according to claim 1, wherein
the overlapping portion is provided with a contact point portion protruding from one of the first conductive member and the second conductive member to the other one thereof and a contact point hole portion in which the contact point portion is accommodated.
